(19) United States
(12) Patent Application Publication
(10) Pub. No.: US 2016/0216486 A1
(43) Pub. Date: Jul. 28, 2016

(54) IMAGING LENS AND IMAGING APPARATUS EQUIPPED WITH THE IMAGING LENS

(71) Applicant: FUJIFILM Corporation, Tokyo (JP)

(72) Inventor: Takuya TANAKA, Saitama-ken (JP)

(73) Assignee: FUJIFILM Corporation, Tokyo (JP)

(21) Appl. No.: 15/002,408

(22) Filed: Jan. 21, 2016

(30) Foreign Application Priority Data
Jan. 27, 2015 (JP) 2015-012941

(51) Int. Cl. G02B 13/00; G02B 27/00; G02B 9/62

(52) U.S. Cl. CPC G02B 13/0045; G02B 9/62; G02B 27/0025

(57) ABSTRACT

An imaging lens is constituted essentially by six lenses, including, in order from the object side to the image side: a first lens having a positive refractive power and is of a meniscus shape with a concave surface toward the object side; a second lens having a positive refractive power and a convex surface toward the object side; a third lens having a negative refractive power; a fourth lens; a fifth lens; and a sixth lens having a negative refractive power. An aperture stop is positioned at the object side of the surface toward the object side of the third lens.

### CROSS REFERENCE TO RELATED APPLICATIONS

The present application claims priority under 35 U.S.C. §119 to Japanese Patent Application No. 2015-012941 filed on Jan. 27, 2015. The above application is hereby expressly incorporated by reference, in its entirety, into the present application.

### BACKGROUND

The present disclosure is related to a fixed focus imaging lens for forming optical images of subjects onto an imaging element such as a CCD (Charge Coupled Device) and a CMOS (Complementary Metal Oxide Semiconductor). The present disclosure is also related to an imaging apparatus provided with the imaging lens that performs photography such as a digital still camera, a surveillance camera, a cellular telephone with a built in camera, a PDA (Personal Digital Assistant), a smart phone, a tablet type terminal, and a portable gaming device.

Accompanying the recent spread of personal computers in households, digital still cameras capable of inputting image data such as photographed scenes and portraits into personal computers are rapidly becoming available. In addition, many cellular telephones, smart phones, and tablet type terminals are being equipped with camera modules for inputting images. Imaging elements such as CCD's and CMOS's are employed in these devices having photography functions. Recently, miniaturization of these imaging elements is advancing, and there is demand for miniaturization of the entirety of the photography devices as well as imaging lenses to be mounted thereon. At the same time, the number of pixels in imaging elements is increasing, and there is demand for high resolution and high performance of imaging lenses. Performance corresponding to 5 megapixels or greater, and more preferably 8 megapixels or greater, is desired.

In response to such demands, imaging lenses having five or more lenses, which is a comparatively large number of lenses, have been proposed. For example, U.S. Pat. No. 8,724,237 discloses an imaging lens having a six lens configuration, which has an even greater number of lenses, in order to improve performance further.

### SUMMARY

Meanwhile, there is demand for a greater widening of the angle of view in imaging lenses having comparatively short total lengths, which are employed in devices such as portable terminals, smart phones, and tablet terminals. A further widening of the angle of view is required in the imaging lens disclosed in U.S. Pat. No. 8,724,237, in order to meet this demand.

The present disclosure has been developed in view of the foregoing points. The present disclosure provides an imaging lens that can achieve a widening of the angle of view while realizing a shortening of the total length, and can realize high imaging performance from a central angle of view to peripheral angles of view. The present disclosure also provides an imaging apparatus equipped with the lens, which is capable of obtaining high resolution photographed images.

An imaging lens of the present disclosure consists of six lenses, including, in order from the object side to the image side:

a first lens having a positive refractive power and is of a meniscus shape with a concave surface toward the object side;

a second lens having a positive refractive power and a convex surface toward the object side;

a third lens having a negative refractive power;

a fourth lens;

a fifth lens; and

a sixth lens having a negative refractive power;

an aperture stop being positioned at the object side of the surface toward the object side of the third lens.

Note that in the imaging lens of the present disclosure, the expression “consists of six lenses” means that the imaging lens of the present disclosure may also include lenses that practically have no power, optical elements other than lenses such as a stop and a cover glass, and mechanical components such as lens flanges, a lens barrel, a camera shake correcting mechanism, etc., in addition to the six lenses. In addition, the shapes of the surfaces of the lenses and the signs of the refractive indices thereof are considered in the paraxial region in the case that the lenses include aspherical surfaces.

The optical performance of the imaging lens of the present disclosure can be further improved by adopting the following favorable configurations.

In the imaging lens of the present disclosure, it is preferable for the second lens to be of a biconvex shape.

In addition, in the imaging lens of the present disclosure, it is preferable for the third lens to have a concave surface toward the object side.

In addition, in the imaging lens of the present disclosure, it is preferable for the fourth lens to have a positive refractive power.

In addition, in the imaging lens of the present disclosure, it is preferable for the fifth lens to have a positive refractive power.

In addition, in the imaging lens of the present disclosure, it is preferable for the fifth lens to be of a meniscus shape having a concave surface toward the object side.

In addition, in the imaging lens of the present disclosure, it is preferable for the sixth lens to be of a meniscus shape having a convex surface toward the object side.

The imaging lens of the present disclosure may satisfy one or arbitrary combinations of Conditional Formulae (1) through (6) and Conditional Formulae (1-1) through (6-1) below

0.1<f/f1<0.6 (1)

0.1<f/f1<0.4 (1−1)

0.6<f/f2<1.1 (2)

0.7<f/f2<1 (2−1)

−1.6<f/f3<−0.4 (3)

−1.2<f/f3<−0.6 (3−1)

1.1<f/f5<1.6 (4)

1,2<f/f5<1.4 (4−1)

−1.9<f/f6<−1.15 (5)

−1.6<f/f6<−1.15 (5−1)

1<f/L6r<6 (6)

3<f/L6r<5 (6−1)

wherein f is the focal length of the entire lens system, f1 is the focal length of the first lens, f2 is the focal length of the second lens, f3 is the focal length of the third lens, f5 is the focal length of the fifth lens, f6 is the focal length of the sixth lens, and L6r is the paraxial radius of curvature of the surface of the sixth lens toward the image side.

An imaging apparatus of the present disclosure is equipped with the imaging lens of the present disclosure.

According to the imaging lens of the present disclosure, the configuration of each lens element is optimized within a lens configuration having six lenses as a whole. Therefore, a lens system that can achieve a wide angle of view, a short total length, and high imaging performance from a central angle of view to peripheral angles of view can be realized.

The imaging apparatus of the present disclosure outputs image signals corresponding to optical images formed by the imaging lens of the present disclosure having high imaging performance. Therefore, the imaging apparatus of the present disclosure is capable of obtaining high resolution photographed images.

### BRIEF DESCRIPTION OF THE DRAWINGS

FIG. 1 is a sectional diagram that illustrates a first example of the configuration of an imaging lens according to an embodiment of the present disclosure, which corresponds to a lens of Example 1, as well as the paths of light rays that pass therethrough.

FIG. 2 is a sectional diagram that illustrates another example of the configuration of an imaging lens according to an embodiment of the present disclosure, which corresponds to a lens of Example 2, as well as the paths of light rays that pass therethrough.

FIG. 3 is a sectional diagram that illustrates still another example of the configuration of an imaging lens according to an embodiment of the present disclosure, which corresponds to a lens of Example 3, as well as the paths of light rays that pass therethrough.

FIG. 4 is a sectional diagram that illustrates still yet another example of the configuration of an imaging lens according to an embodiment of the present disclosure, which corresponds to a lens of Example 4, as well as the paths of light rays that pass therethrough.

FIG. 5 is a collection of diagrams that illustrate aberrations of the imaging lens of Example 1, wherein the diagrams illustrate spherical aberration, astigmatism, distortion, and lateral chromatic aberration, in this order from the left side of the drawing sheet.

FIG. 6 is a collection of diagrams that illustrate aberrations of the imaging lens of Example 2, wherein the diagrams illustrate spherical aberration, astigmatism, distortion, and lateral chromatic aberration, in this order from the left side of the drawing sheet.

FIG. 7 is a collection of diagrams that illustrate aberrations of the imaging lens of Example 3, wherein the diagrams illustrate spherical aberration, astigmatism, distortion, and lateral chromatic aberration, in this order from the left side of the drawing sheet.

FIG. 8 is a collection of diagrams that illustrate aberrations of the imaging lens of Example 4, wherein the diagrams illustrate spherical aberration, astigmatism, distortion, and lateral chromatic aberration, in this order from the left side of the drawing sheet.

FIG. 9 is a diagram that illustrates a cellular telephone as an imaging apparatus equipped with the imaging lens of the present disclosure.

FIG. 10 is a diagram that illustrates a smart phone as an imaging apparatus equipped with the imaging lens of the present disclosure.

### DETAILED DESCRIPTION OF THE PREFERRED EMBODIMENTS

Hereinafter, embodiments of the present disclosure will be described in detail with reference to the attached drawings.

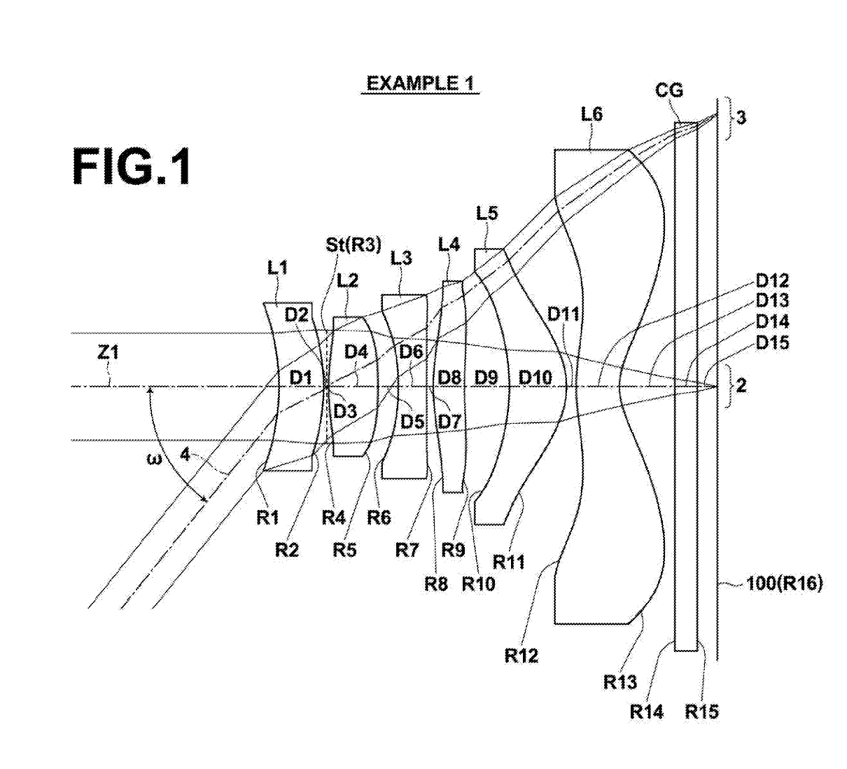

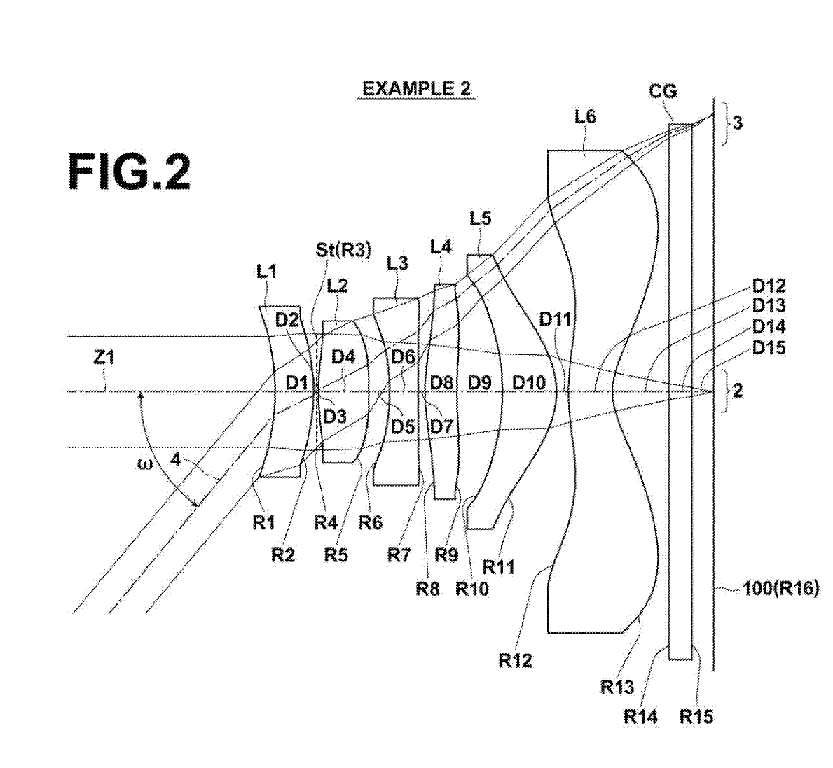

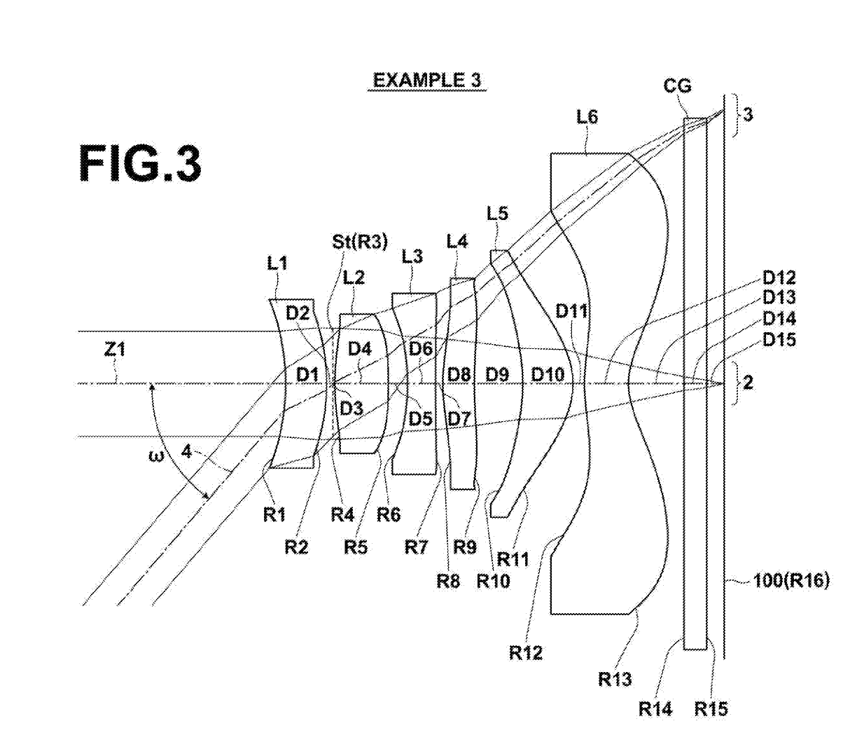

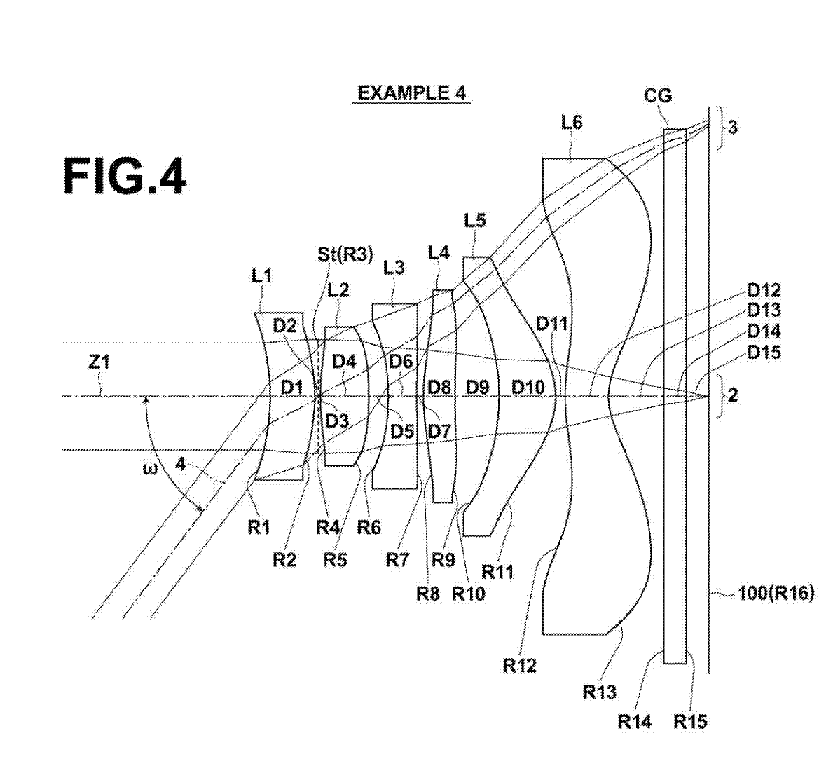

FIG. 1 illustrates a first example of the configuration of an imaging lens according to an embodiment of the present disclosure. This example corresponds to the lens configuration of Numerical Example 1 (Table 1 and Table 2), to be described later. In addition, FIG. 1 also illustrates the paths of an axial light beam 2 and a maximum angle of view light beam 3 in a state focused on an object at a distance of infinity, and the half value co of the maximum angle of view. Note that a principal light ray 4 of the maximum angle of view light beam 3 is indicated by a single dot chained line. Similarly; FIG. 2 through FIG. 4 are sectional diagrams that illustrate second through fourth examples of lens configurations that correspond to Numerical Examples 2 through 4 (Table 3 through Table 8). In FIGS. 1 through 4, the symbol Ri represents the radii of curvature of ith surfaces, i being lens surface numbers that sequentially increase from the object side to the image side (imaging side), with the surface of a lens element most toward the object side designated as first. The symbol Di represents the distances between an ith surface and an i+1st surface along an optical axis Z1. Note that the basic configurations of the examples are the same, and therefore a description will be given of the imaging lens of FIG. 1 as a base, and the examples of FIGS. 2 through 4 will also be described as necessary.

The imaging lens L of the embodiment of the present disclosure is favorably employed in various imaging devices that employ imaging elements such as a. CCD and a CMOS. The imaging lens L of the embodiment of the present disclosure is particularly favorable for use in comparatively miniature portable terminal devices, such as a digital still camera, a surveillance camera, a cellular telephone with a built in camera, a smart phone, a tablet type terminal, and a PDA. The imaging lens L is equipped with, in order from the object side to the image side along the optical axis Z1, a first lens L1, a second lens L2, a third lens L3, a fourth lens L4, a fifth lens L5, and a sixth lens L6.

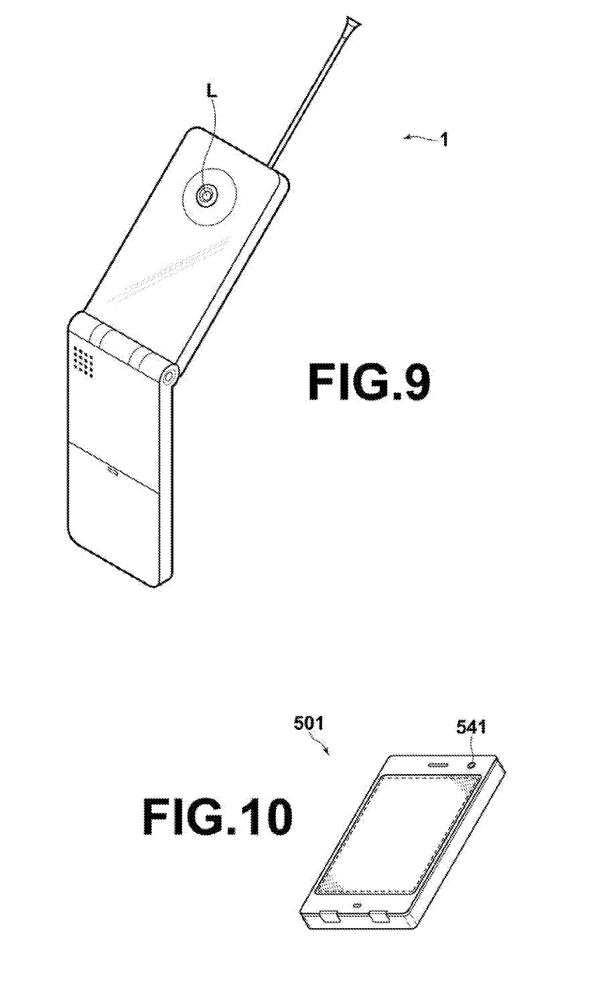

FIG. 9 schematically illustrates a cellular telephone as an imaging apparatus 1 according to an embodiment of the present disclosure. The imaging apparatus 1 of the embodiment of the present disclosure is equipped with the imaging lens L according to the embodiment of the present disclosure and an imaging element 100 (refer to FIGS. 1 through 4) such as a CCD that outputs image signals corresponding to optical images formed by the imaging lens L. The imaging element 100 is provided at an image formation plane (imaging surface R16 in FIGS. 1 through 4) of the imaging lens L.

FIG. 10 schematically illustrates a smart phone as an imaging apparatus 501 according to an embodiment of the present disclosure. The imaging apparatus 501 of the embodiment of the present disclosure is equipped with a camera section 541 having the imaging lens L according to the embodiment of the present disclosure and an imaging element 100 (refer to FIGS. 1 through 4) such as a CCD that outputs image signals corresponding to optical images formed by the imaging lens L. The imaging element 100 is provided at an image formation plane (imaging surface) of the imaging lens L.

Various optical members CG may be provided between the sixth lens L6 and the imaging element 100, depending on the configuration of the camera to which the lens is applied. A planar optical member such as a cover glass for protecting the imaging surface and an infrared cutoff filter may be provided, for example. In this case, a planar cover glass having a coating having a filtering effect such as an infrared cutoff filter coating or an ND (Neutral Density) filter coating, or a material that exhibits similar effects, may be utilized as the optical member CG:

Alternatively, the optical member CG may be omitted, and a coating may be administered on the sixth lens L6 to obtain the same effect as that of the optical member CG In this case, the number of parts can be reduced, and the total length can be shortened.

It is preferable for the imaging lens L to be equipped with an aperture stop St positioned at the object side of the surface of the third lens L3 toward the object side. In the case that the aperture stop St is positioned at the object side of the surface of the third lens L3 toward the object side in this manner, increases in the incident angles of light rays that pass through the optical system and enter the image formation plane (imaging element) can be suppressed, particularly at peripheral portions of an imaging region. In addition, in the case that the aperture stop St is positioned at the object side of the surface of the second lens L2 toward the object side as illustrated in each of the embodiments, this advantageous effect can become more prominent. Note that the expression “positioned at the object side of the surface of the third lens L3 toward the object side” means that the position of the aperture stop in the direction of the optical axis is at the same position as the intersection of marginal axial rays of light and the surface of the third lens L3 toward the object side, or more toward the object side than this position. Similarly, the expression “positioned at the object side of the surface of the second lens L2 toward the object side” means that the position of the aperture stop in the direction of the optical axis is at the same position as the intersection of marginal axial rays of light and the surface of the second lens L2 toward the object side, or more toward the object side than this position. Note that the aperture stop St illustrated here does not necessarily represent the size or the shape thereof, but the position of the aperture stop St along the optical axis Z1.

The first lens L1 is of a meniscus shape having a concave surface toward the object side in the vicinity of the optical axis. A widening of the angle of view can be favorably achieved, by configuring the surface of the first lens L1 toward the object side, which is the surface most toward the object side within the imaging lens L, to be concave toward the object side. Further, the first lens L1 has a positive refractive power in the vicinity of the optical axis. This configuration is advantageous from the viewpoint of realizing shortening the total length of the lens system.

The second lens L2 has a positive refractive power in the vicinity of the optical axis. Thereby, a shortening of the total length of the lens system can be favorably realized. In addition, the second lens L2 has a convex surface toward the object side in the vicinity of the optical axis. For this reason, moving the position of the rearward principal point of the second lens L2 toward the object side is further facilitated, which is advantageous from the viewpoint of shortening the total length of the lens system. In addition, it is preferable for the second lens L2 to be of a biconvex shape in the vicinity of the optical axis. In this case, the positive refractive power of the second lens L2 can be distributed between the surface of the second lens L2 toward the object side and the surface of the second lens L2 toward the image side. As a result, the absolute values of the paraxial radii of curvatures of the surface of the second lens L2 toward the object side and the surface of the second lens L2 toward the image side can be prevented from becoming excessively small, and spherical aberration can be favorably corrected.

The third lens L3 has a negative refractive power in the vicinity of the optical axis. Thereby, spherical aberration and chromatic aberrations can be favorably corrected. In addition, it is preferable for the third lens L3 to have a concave surface toward the object side in the vicinity of the optical axis. In this case, spherical aberration and astigmatism can be favorably corrected, and a widening of the angle of view can be favorably realized. In addition, the third lens may be of a biconcave shape in the vicinity of the optical axis. In this case, the negative refractive power of the third lens L3 can be distributed between the surface of the third lens L3 toward the object side and the surface of the third lens L3 toward the image side. As a result, the absolute values of the paraxial radii of curvatures of the surface of the third lens L3 toward the object side and the surface of the third lens L3 toward the image side can be prevented from becoming excessively small, and spherical aberration can be more favorably corrected.

Here, in the imaging lens L having the aperture stop St positioned at the object side of the surface of the third lens L3 toward the object side, it is preferable for a plurality of lenses for correcting aberrations to be provided more toward the image side than the surface of the third lens L3 toward the image side, in order to correct various aberrations which are generated accompanying a widening of the angle of view. The imaging lens L is equipped with the fourth lens L4, the fifth lens L5, and the sixth lens L6, which are provided more toward the image side than the surface of the third lens L3 toward the image side. Therefore, various aberrations which are generated accompanying a widening of the angle of view can be favorably corrected. In addition, by positioning two lenses, which are the fourth lens L4 and the fifth lens L5, between the third lens L3 positioned at the image side of the aperture stop St and the sixth lens L6, which is positioned most toward the image side, various aberrations can be corrected, while suppressing an increase in the total length of the lens system due to an increased number of lenses. In addition, it is preferable for at least one of the surface of the fourth lens L4 toward the image side and the surface of the fourth lens L4 toward the object side to be aspherical, in order to more favorably correct various aberrations. It is more preferable for both surfaces of the fourth lens L4 to be aspherical. For the same reason, it is preferable for at least one of the surface of the fifth lens L5 toward the image side and the surface of the fifth lens L5 toward the object side to be aspherical, and more preferable for both surfaces of the fifth lens L5 to be aspherical.

The fourth lens L4 and the fifth lens L5 may have negative refractive powers or positive refractive powers in the vicinity of the optical axis, as long as they are capable of correcting various aberrations which are generated as light rays pass through the imaging lens L in a well balanced manner. For example, the fourth lens L4 may be configured to have a positive refractive power in the vicinity of the optical axis. In this case, a shortening of the total length of the lens system can be favorably realized. In addition, the height of an of axis principal light ray that passes through the fourth lens L4 is lower (the distance from the optical axis is shorter) than the height of the off axis principal light ray that passes through the fifth lens L5, while the height of an on axis marginal light ray that passes through the fourth lens L4 is higher (the distance from the optical axis is longer) than the on axis marginal light ray that passes through the fifth lens L5. Therefore, configuring the fourth lens L4 to have a positive refractive power is advantageous from the viewpoint of correcting spherical aberration. In addition, it is preferable for the fourth lens LA to be of a meniscus shape with a convex surface toward the object side in the vicinity of the optical axis. In this case, a shortening of the total length of the lens system can be favorably achieved.

In addition, the fifth lens L5 may be configured to have a positive refractive power in the vicinity of the optical axis. In this case, a shortening of the total length of the lens system can be favorably realized. In addition, the height of an off axis principal light ray that passes through the fifth lens L5 is higher (the distance from the optical axis is longer) than the height of the off axis principal light ray that passes through the fourth lens L4, while the height of an on axis marginal light ray that passes through the fifth lens L5 is lower (the distance from the optical axis is shorter) than the on axis marginal light ray that passes through the fourth lens L4. Therefore, configuring the fifth lens L5 to have a positive refractive power is advantageous from the viewpoint of correcting distortion. In addition, it is preferable for the fifth lens L5 to be of a meniscus shape with a concave surface toward the object side in the vicinity of the optical axis. In this case, astigmatism, which is generated accompanying a widening of the angle of view, can be favorably corrected, while a small F number can be achieved.

The sixth lens L6 has a negative refractive power in the vicinity of the optical axis. By configuring the sixth lens L6, which is the lens provided most toward the image side within the imaging lens L, to have a negative refractive power in the vicinity of the optical axis, the position of the rearward principal point of the imaging lens L can be moved toward the object side. As a result, the total length of the lens system can be favorably shortened. In addition, it is preferable for the sixth lens L6 to be of a meniscus shape having a convex surface toward the object side in the vicinity of the optical axis. Configuring the surface of the sixth lens L6 toward the object side to be of a convex shape in the vicinity of the optical axis is advantageous from the viewpoint of shortening the total length of the lens system. In addition, field curvature can be favorably corrected, by configuring the surface of the sixth lens L6 toward the image side to be of a concave shape in the vicinity of the optical axis.

In addition, it is preferable for the surface of the sixth lens L6 toward the image side to be of an aspherical shape having at least one inflection point at a position in an inwardly radial direction from the intersection of a principal light ray at a maximum angle of view and the surface of the sixth lens L6 toward the image side to the optical axis. In this case, increases in the incident angles of light rays that pass through the optical system at and enter the image formation plane (imaging element) can be suppressed, particularly at the peripheral portions of the imaging region. In addition, distortion can be favorably corrected, by the surface of the sixth lens L6 toward the image side being of an aspherical shape having at least one inflection point at a position in an inwardly radial direction from the intersection of a principal light ray at a maximum angle of view and the surface of the sixth lens L6 toward the image side to the optical axis. Note that the “inflection point” on the surface of the sixth lens L6 toward the image side refers to a point at which the shape of the surface of the sixth lens L6 toward the image side changes from a convex shape to a concave shape (or from a concave shape to a convex shape) with respect to the image side. In addition, in the present specification, the expression “a position in an inwardly radial direction from the intersection of a principal light ray at a maximum angle of view and the surface toward the image side to the optical axis” refers to positions at the intersection of a principal light ray at a maximum angle of view and the surface toward the image side to the optical axis and positions radially inward toward the optical axis from these positions. In addition, the inflection point on the surface of the sixth lens L6 toward the image side may be provided at arbitrary positions at the intersection of a principal light ray at a maximum angle of view and the surface of the sixth lens L6 toward the image side to the optical axis and at any arbitrary position radially inward toward the optical axis from these positions.

In addition, in the case that each of the first lens L1 through the sixth lens L6 that constitute the imaging lens L is a single lens, not a cemented lens, the number of lens surfaces will be greater than that for a case in which any of the first lens L1 through the sixth lens L6 is a cemented. Therefore, the degree of freedom in the design of each lens will increase. As a result, the total length of the lens can be favorably shortened.

According to the imaging lens L described above, the configurations of each of the first lens L1 through the sixth lens L6 are optimized as lens elements in a lens configuration having a total of six lenses. Therefore, a lens system that achieves a shortening of the total length and a widening of the angle of view, and has high imaging performance from a central angle of view to peripheral angles of view, can be realized.

It is preferable for at least one of the surfaces of each of the first lens L1 through the sixth lens L6 of the imaging lens L to be an aspherical surface, in order to improve performance.

Next, the operation and effects of conditional formulae related to the imaging lens L will be described in greater detail. Note that it is preferable for the imaging lens L to satisfy any one of the following conditional formulae, or arbitrary combinations of the following conditional formulae. It is preferable for the conditional formulae to be satisfied to be selected as appropriate according to the items required of the imaging lens L.

It is preferable for the focal length f1 of the first lens L1 and the focal length f of the entire lens system to satisfy Conditional Formula (1) below.

0.1<f/f1<0.6 (1)

Conditional Formula (1) defines a preferable range of numerical values for the ratio of the focal length f of the entire lens system with respect to the focal length f1 of the first lens L1. By securing the refractive power of the first lens L1 such that the value of f/f1 is not less than or equal to the lower limit defined in Conditional Formula (1), the positive refractive power of the first lens L1 will not become excessively weak with respect to the refractive power of the entire lens system. As a result, the total length of the lens can be favorably shortened. In addition, by suppressing the refractive power of the first lens L1 such that the value of f/f1 is not greater than or equal to the upper limit defined in Conditional Formula (1), the positive refractive power of the first lens L1 will not become excessively strong with respect to the refractive power of the entire lens system. As a result, distortion and astigmatism can be suppressed, while a wide angle of view can be secured. It is more preferable for Conditional Formula (1-1) to be satisfied, in order to cause these advantageous effects to become more prominent.

0.1<f/f1<0.4 (1-1).

In addition, it is preferable for the focal length f2 of the second lens L2 and the focal length f of the entire lens system to satisfy Conditional Formula (2) below.

0.6<f/f2<1.1 (2)

Conditional Formula (2) defines a preferable range of numerical values for the ratio of the focal length f of the entire lens system with respect to the focal length f2 of the second lens L2. By securing the refractive power of the second lens L2 such that the value of f/f2 is not less than or equal to the lower limit defined in Conditional Formula (2), the positive refractive power of the second lens L2 will not become excessively weak with respect to the refractive power of the entire lens system. As a result, the total length of the lens can be favorably shortened. In addition, by suppressing the refractive power of the second lens L2 such that the value of f/f2 is not greater than or equal to the upper limit defined in Conditional Formula (2), the positive refractive power of the second lens L2 will not become excessively strong with respect to the refractive power of the entire lens system. As a result, spherical aberration and astigmatism at low angles of view can be favorably corrected. It is more preferable for Conditional Formula (2-1) to be satisfied, in order to cause these advantageous effects to become more prominent.

0.7<f/f2<1 (2-1).

In addition, it is preferable for the focal length f3 of the third lens L3 and the focal length f of the entire lens system to satisfy Conditional Formula (3) below.

−1.6<f/f3<−0.4 (3)

Conditional Formula (3) defines a preferable range of numerical values for the ratio of the focal length f of the entire lens system with respect to the focal length f3 of the third lens L3. By suppressing the refractive power of the third lens L3 such that the value of f/f3 is not less than or equal to the lower limit defined in Conditional Formula (3), the refractive power of the third lens L3 will not become excessively strong with respect to the refractive power of the entire lens system. As a result, the total length of the lens can be favorably shortened. In addition, by securing the refractive power of the third lens L3 such that the value of f/f3 is not greater than or equal to the upper limit defined in Conditional Formula (3), the refractive power of the third lens L3 will not become excessively weak with respect to the refractive power of the entire lens system. As a result, spherical aberration and longitudinal chromatic aberration can be favorably corrected, and a small F number can be achieved. It is more preferable for Conditional Formula (3-1) to be satisfied, in order to cause these advantageous effects to become more prominent.

−1.2<f/f3<−0.6 (3-1).

In addition, it is preferable for the focal length f5 of the fifth lens L5 and the focal length f of the entire lens system to satisfy Conditional Formula (4) below.

1.1<f/f5<1.6 (4)

Conditional Formula (4) defines a preferable range of numerical values for the ratio of the focal length f of the entire lens system with respect to the focal length f5 of the fifth lens L5. By securing the refractive power of the fifth lens L5 such that the value of f/f5 is not less than or equal to the lower limit defined in Conditional Formula (4), the positive refractive power of the fifth lens L5 will not become excessively weak with respect to the refractive power of the entire lens system. As a result, the total length of the lens can be favorably shortened. In addition, by suppressing the refractive power of the fifth lens L5 such that the value of f/f5 is not greater than or equal to the upper limit defined in Conditional Formula (4), the positive refractive power of the fifth lens L5 will not become excessively strong with respect to the refractive power of the entire lens system. As a result, lateral chromatic aberration can be favorably corrected. It is more preferable for Conditional Formula (4-1) to be satisfied, in order to cause these advantageous effects to become more prominent.

1.2<f/f5<1.4 (4-1).

In addition, it is preferable for the focal length f6 of the sixth lens L6 and the focal length f of the entire lens system to satisfy Conditional Formula (5) below.

−1.9<f/f6<−1.15 (5)

Conditional Formula (5) defines a preferable range of numerical values for the ratio of the focal length f of the entire lens system with respect to the focal length f6 of the sixth lens L6. By suppressing the refractive power of the sixth lens L6 such that the value of f/f6 is not less than or equal to the lower limit defined in Conditional Formula (5), the refractive power of the sixth lens L6 will not become excessively strong with respect to the refractive power of the entire lens system. As a result, increases in the incident angles of light rays that pass through the optical system then enter the image formation plane (imaging element) can be suppressed, particularly at intermediate angles of view. In addition, by securing the refractive power of the sixth lens L6 such that the value of f/f6 is not greater than or equal to the upper limit defined in Conditional Formula (5), the refractive power of the sixth lens L6 will not become excessively weak with respect to the refractive power of the entire lens system. As a result, the total length of the lens system can be favorably shortened. It is more preferable for Conditional Formula (5-1) to be satisfied, in order to cause these advantageous effects to become more prominent.

−1.6<f/f6<−1.15 (5-1),

In addition, it is preferable for the focal length f of the entire lens system and the paraxial radius of curvature L6r of the surface of the sixth lens L6 toward the image side to satisfy Conditional Formula (6) below.

1<f/L6r<6 (6)

Conditional Formula (6) defines a preferable range of numerical values for the ratio of the focal length f of the entire lens system with respect to the paraxial radius of curvature L6r of the surface of the sixth lens L6 toward the image side. By setting the paraxial radius of curvature L6r of the surface of the sixth lens L6 toward the image side such that the value of f/L6r is not less than or equal to the lower limit defined in Conditional Formula (6), the absolute value of the paraxial radius of curvature L6r of the surface of the sixth lens L6 toward the image side with respect to the focal length f of the entire lens system will not become excessively large. This configuration is advantageous from the viewpoint of shortening the total length of the lens system. By setting the paraxial radius of curvature L6r of the surface of the sixth lens L6 toward the image side such that the value of f/L6r is not greater than or equal to the upper limit defined in Conditional Formula (6), the absolute value of the paraxial radius of curvature L6r of the surface of the sixth lens L6 toward the image side with respect to the focal length f of the entire lens system will not become excessively small. As a result, field curvature and distortion can be favorably corrected, particularly at intermediate angles of view. It is more preferable for Conditional Formula (6-1) to be satisfied, in order to cause these advantageous effects to become more prominent.

3<f/L6r<5 (6-1).

As described above, in the imaging lens L according to the embodiment of the present disclosure, the configurations of each lens element is optimized in a lens configuration having a total of six lenses. Therefore, a lens system that achieves a shortened total length and a wide angle of view, and has high imaging performance from a central angle of view to peripheral angles of view, can be realized.

In addition, further improved imaging performance can be realized by satisfying preferred conditions as appropriate. In addition, the imaging apparatuses according to the embodiments of the present disclosure output image signals corresponding to optical images formed by the high performance imaging lenses according to the embodiments of the present disclosure. Therefore, photographed images having high resolution from a central angle of view to peripheral angles of view can be obtained.

In addition, if the distance along the optical axis from the surface of the first lens L1 toward the object side to the imaging surface, with back focus as an air converted length, is designated as TTL, the imaging lens L of the embodiment of the present disclosure realizes a widening of the angle of view such that the maximum angle of view in a state focused on an object at infinity is 90 degrees or greater, and a shortening of the total length of the lens system such that the value of TTL/f is 1.8 or less. For this reason, the imaging lens L may be favorably applied as an imaging lens L for use in imaging apparatuses such as portable terminals, which require short total lengths and wide angles of view. Further, the first lens L1 through the sixth lens L6 of the imaging lenses L of the first through fourth embodiments are configured such that the maximum angle of view in a state focused on an object at infinity is 95 degrees or greater. Therefore, demand for even wider angles of view can be favorably satisfied. In addition, the first lens L1 through the sixth lens L6 of the imaging lenses IL of the first through fourth embodiments are configured such that F number is 2.4 or less. For this reason, demand to realize small F numbers in imaging apparatuses such as portable terminals can also be favorably satisfied.

Next, specific examples of numerical values of the imaging lens of the present disclosure will be described. A plurality of examples of numerical values will be summarized and explained below.

Table 1 and Table 2 below show specific lens data corresponding to the configuration of the imaging lens illustrated in FIG. 1. Table 1 shows basic lens data of the imaging lens, and Table 2 shows data related to aspherical surfaces. In the lens data of Table 1, ith lens surface numbers that sequentially increase from the object side to the image side, with the lens surface at the most object side designated as first, are shown in the column Si for the imaging lens of Example 1. The radii of curvature (mm) of ith surfaces from the object side corresponding to the symbols Ri illustrated in FIG. 1 are shown in the column Ri. Similarly, the distances (mm) between an ith surface Si and an i+1st surface Si+1 from the object side along the optical axis are shown in the column Di. The refractive indices of jth optical elements from the object side with respect to the d line (wavelength: 587.6 nm) are shown in the column Ndj. The Abbe's numbers of the jth optical elements with respect to the d line are shown in the column vdj.

Table 1 also shows the aperture stop St and the optical member CG. In Table 1, “(St)” is indicated along with a surface number in the row of the surface number of the surface that corresponds to the aperture stop St, and “(MG)” is indicated along with a surface number in the row of the surface number of the surface that corresponds to the imaging surface. The signs of the radii of curvature are positive for surface shapes having convex surfaces toward the object side, and negative for surface shapes having convex surfaces toward the image side. Note that the values of the focal length f (mm) of the entire lens system, the back focus Bf (mm), the F number Fno, the maximum angle of view 2ω)(°), and the ratio TTL/f of the distance TTL from the surface of the first lens L1 toward the object side to the imaging surface along the optical axis in a state focused on an object at infinity are shown as data above the lens data. Note that the back focus Bf is represented as an air converted value. In addition, the back focus is an air converted value also in of the distance TTL from the surface of the first lens L1 toward the object side to the imaging surface along the optical axis.

In the imaging lens of Example 1, both of the surfaces of the first lens L1 through the sixth lens L6 are all aspherical in shape. In the basic lens data of Table 1, numerical values of radii of curvature in the vicinity of the optical axis (paraxial radii of curvature) are shown as the radii of curvature of the aspherical surfaces.

Table 2 shows aspherical surface data of the imaging lens of Example 1. In the numerical values shown as the aspherical surface data, the symbol “E” indicates that the numerical value following thereafter is a “power index” having 10 as a base, and that the numerical value represented by the index function having 10 as a base is to be multiplied by the numerical value in front of “E”. For example, “1.0E-02” indicates that the numerical value is “1.0·10⁻²”.

The values of coefficients An and KA represented by the aspherical surface shape formula (A) below are shown as the aspherical surface data. In greater detail, Z is the length (mm) of a normal line that extends from a point on the aspherical surface having a height h to a plane (a plane perpendicular to the optical axis) that contacts the apex of the aspherical surface.

$$Z = \frac{C \times {h}^{2}}{1 + \sqrt{1 - KA \times {C}^{2} \times {h}^{2}}} + {\sum }_{n} An \times {h}^{n} \qquad ( A )$$

wherein: Z is the depth of the aspherical surface (mm), h is the distance from the optical axis to the surface of the lens (height) (mm), C is the paraxial curvature=1/R (R is the paraxial radius of curvature), An is an nth ordinal aspherical surface coefficient (n is an integer 3 or greater), and KA is an aspherical surface coefficient.

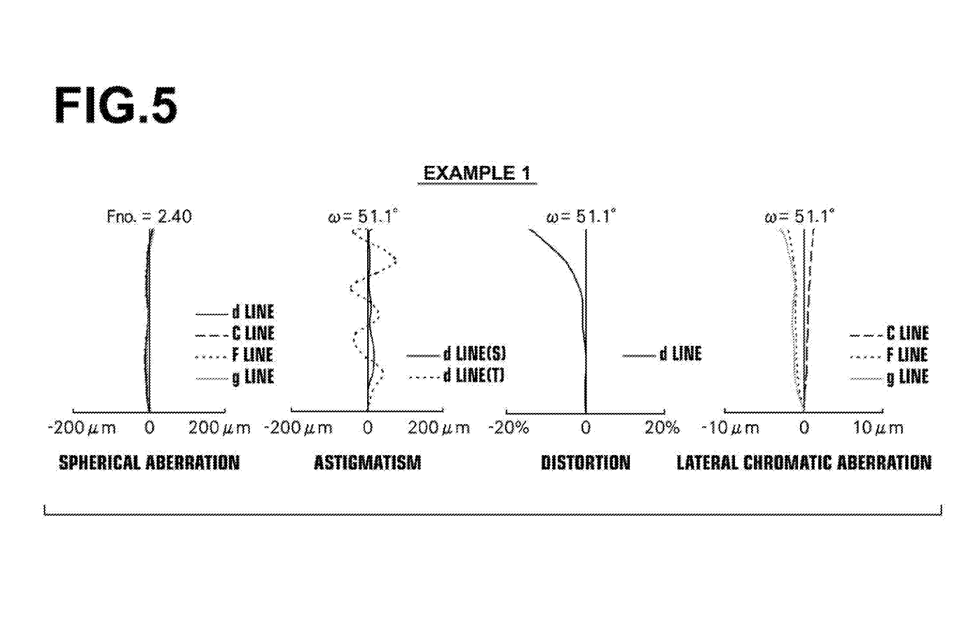

Specific lens data corresponding to the configurations of the imaging lenses illustrated in FIG. 2 through FIG. 4 are shown in Table 3 through Table 8 as Example 2 through Example 4. In the imaging lenses of Examples 1 through 4, both of the surfaces of the first lens L1 through the sixth lens L6 are all aspherical surfaces. FIG. 5 is a collection of diagrams that illustrate aberrations of the imaging lens of Example 1, wherein the diagrams illustrate the spherical aberration, the astigmatism, the distortion, and the lateral chromatic aberration (chromatic aberration of magnification) of the imaging lens of Example 1, respectively, in this order from the left side of the drawing sheet. Each of the diagrams that illustrate the spherical aberration, the astigmatism (field curvature), and the distortion illustrate aberrations using the d line (wavelength: 587.6 nm) as a reference wavelength. The diagram that illustrates spherical aberration also shows aberrations related to the F line (wavelength: 486.1 nm), the C line (wavelength: 656.3 nm) and the g line (wavelength: 435.8 nm). The diagram that illustrates lateral chromatic aberration shows aberrations related to the F line, the C line, and the g line. In the diagram that illustrates astigmatism, aberration in the sagittal direction (S) is indicated by a solid line, while aberration in the tangential direction (T) is indicated by a broken line. In addition, “Fno.” denotes F numbers, and “ω” denotes a half value of the maximum angle of view in a state focused on an object at infinity.

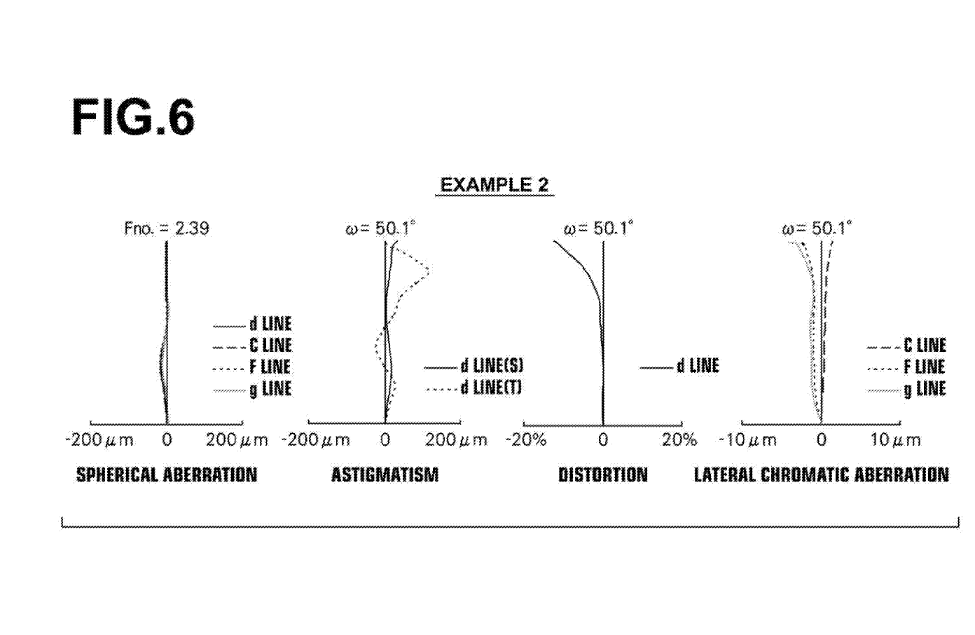

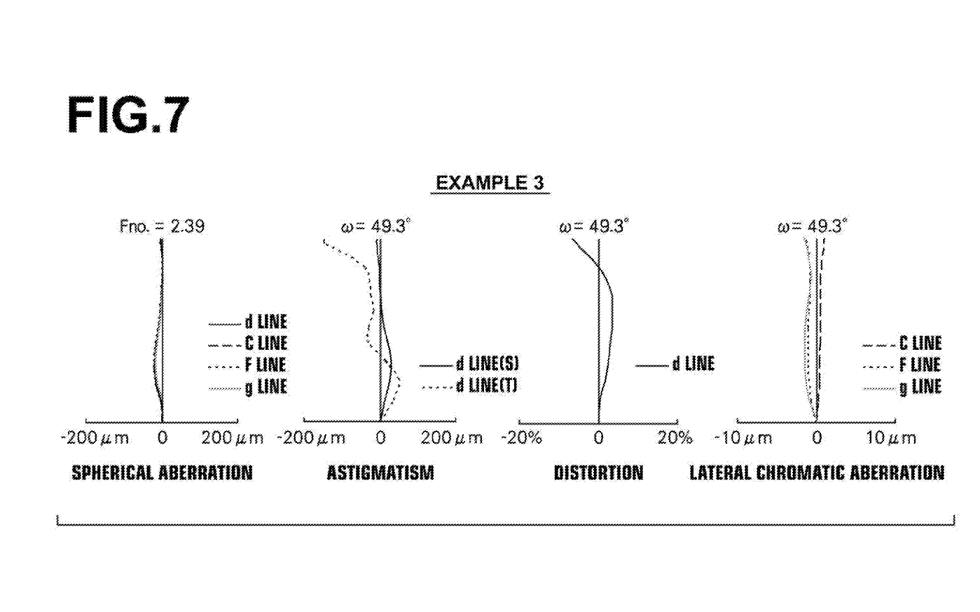

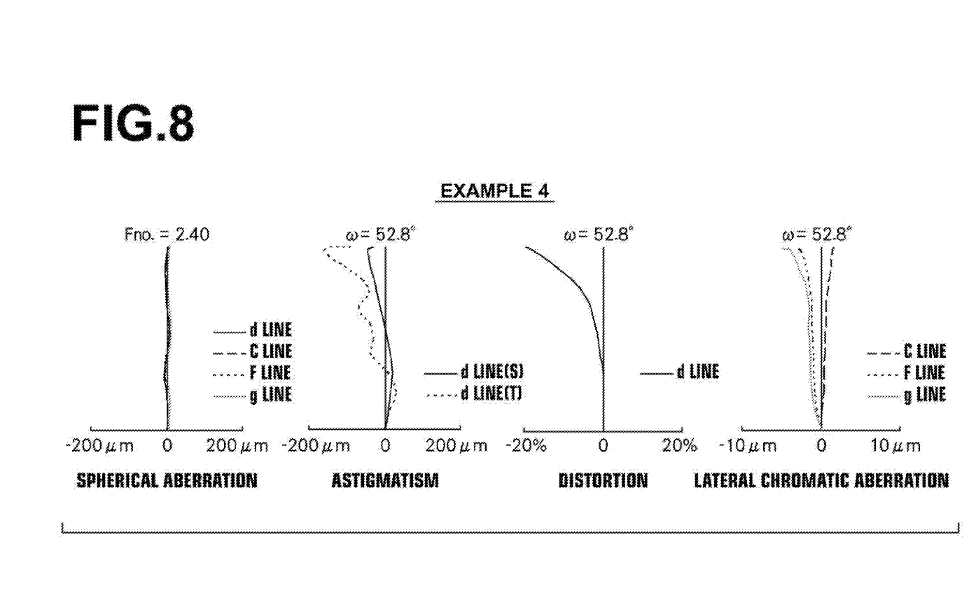

Similarly, the aberrations of the imaging lens of Example 2 through Example 4 are illustrated in FIG. 6 through FIG. 8. The diagrams that illustrate aberrations of FIG. 5 through FIG. 8 are all for cases in which the object distance is infinity.

In addition, Table 9 shows values corresponding to Conditional Formulae (1) through (6), respectively summarized for each of Examples 1 through 4.

As can be understood from each set of numerical value data and from the diagrams that illustrate aberrations, each of the Examples realize a shortening of the total length of the lens, a widening of the angle of view, and high imaging performance.

Note that the imaging lens of the present disclosure is not limited to the embodiments and Examples described above, and various modifications are possible. For example, the values of the radii of curvature, the distances among surfaces, the refractive indices, the Abbe's numbers, the aspherical surface coefficients, etc., are not limited to the numerical values indicated in connection with the Examples of numerical values, and may be other values.

In addition, the Examples are described under the presumption that they are to be utilized with fixed focus. However, it is also possible for configurations capable of adjusting focus to be adopted. It is possible to adopt a configuration, in which the entirety of the lens system is fed out or a portion of the lenses is moved along the optical axis to enable automatic focus, for example.

TABLE 1
Example 1
f = 2.349, Bf = 0.832, Fno. = 2.40, 2ω = 102.2, TTL/f = 1.70

| Si | Ri | Di | Ndj | νdj |
|---|---|---|---|---|
| *1 | −2.13258 | 0.415 | 1.54436 | 56.03 |
| *2 | −1.80745 | 0.030 | | |
| 3 (St) | ∞ | 0.018 | | |
| *4 | 2.41534 | 0.455 | 1.54436 | 56.03 |
| *5 | −3.84906 | 0.190 | | |
| *6 | −1.94628 | 0.260 | 1.63350 | 23.62 |
| *7 | 11.63736 | 0.060 | | |
| *8 | 1.48455 | 0.290 | 1.54436 | 56.03 |
| *9 | 3.76866 | 0.415 | | |
| *10 | −1.89934 | 0.530 | 1.54436 | 56.03 |
| 11 | −0.69822 | 0.090 | | |
| *12 | 1.70293 | 0.400 | 1.54436 | 56.03 |
| *13 | 0.55103 | 0.511 | | |
| 14 | ∞ | 0.210 | 1.51633 | 64.14 |
| 15 | ∞ | 0.183 | | |
| 16 (IMG) | ∞ | | | |

*aspherical surface

TABLE 2
Example 1: Aspherical Surface Data

| Surface | | | | | |
|---|---|---|---|---|---|
| Number | KA | A3 | A4 | A5 | A6 |
| 1 | 4.6907017E+00 | 0.0000000E+00 | 3.5251457E−01 | −4.7963653E+00 | 2.9786084E+01 |
| 2 | −4.5302727E+01 | 0.0000000E+00 | −3.4357956E+00 | 4.6008780E+01 | −3.9345838E+02 |
| 4 | 6.7221586E+00 | 0.0000000E+00 | −1.8670375E+00 | 2.4275582E+01 | −1.1895180E+02 |
| 5 | 1.8363528E+01 | 0.0000000E+00 | 3.1761444E−01 | −1.9989936E+01 | 2.0566127E+02 |
| 6 | −2.7675195E−01 | 0.0000000E+00 | 1.0678218E+00 | −1.7168988E+01 | 1.1439370E+02 |
| 7 | −5.0000000E+01 | 0.0000000E+00 | 1.8248981E+00 | −2.7459567E+01 | 1.4794276E+02 |
| 8 | 6.8883220E−01 | 0.0000000E+00 | 7.8551789E−02 | −3.1100256E+01 | 3.0232207E+02 |
| 9 | 3.7810643E+00 | 0.0000000E+00 | −1.7556397E+00 | 8.2294036E+00 | 5.1885921E+00 |
| 10 | −1.9079704E+01 | 0.0000000E+00 | −9.6996002E−01 | 5.8080063E+00 | −2.2311241E+01 |
| 11 | −2.3348619E−01 | 0.0000000E+00 | 5.1256519E−01 | −2.5159197E−01 | −1.1017812E+00 |
| 12 | 2.8906592E−01 | 0.0000000E+00 | −4.4109707E−01 | −8.3600303E−01 | 3.6265388E+00 |
| 13 | −2.5984865E+00 | 0.0000000E+00 | −2.5114239E−01 | −3.7660126E−02 | 6.3591026E−01 |
| | A7 | A8 | A9 | A10 | A11 |
| 1 | −9.2957114E+01 | 1.3149066E+02 | 3.5184504E+01 | −4.0509841E+02 | 5.1445052E+02 |
| 2 | 2.0396175E+03 | −6.0201644E+03 | 7.2153374E+03 | 1.0722483E+04 | −4.7257922E+04 |
| 4 | 4.0487889E+01 | 2.3307067E+03 | −1.2518924E+04 | 3.0636346E+04 | −2.7028398E+04 |
| 5 | −1.1184013E+03 | 3.3721230E+03 | −4.4967789E+03 | −3.5149379E+03 | 2.0223507E+04 |
| 6 | −4.4303944E+02 | 9.9117914E+02 | −9.1290833E+02 | −1.4638088E+03 | 6.4506444E+03 |
| 7 | −4.1736967E+02 | 6.0323147E+02 | −1.3304062E+02 | −9.6166608E+02 | 1.2196465E+03 |
| 8 | −1.4996222E+03 | 4.3874418E+03 | −7.3926172E+03 | 5.1014030E+03 | 5.5839827E+03 |
| 9 | −1.8064588E+02 | 6.5453880E+02 | −9.6338368E+02 | 2.3462441E+02 | 8.6771480E+02 |
| 10 | 4.7748566E+01 | −4.8417896E+01 | 7.8344580E+00 | 5.6383404E+00 | 6.5505533E+01 |
| 11 | 3.8093092E+00 | −1.3999986E+01 | 3.7918821E+01 | −5.8752828E+01 | 4.8123103E+01 |
| 12 | −5.7869914E+00 | 5.5713783E+00 | −3.4739343E+00 | 1.4043326E+00 | −5.2681257E−01 |
| 13 | −7.9429249E−01 | 3.1558610E−01 | 3.0402459E−01 | −5.1007123E−01 | 2.9404391E−01 |
| | A12 | A13 | A14 | A15 | A16 |
| 1 | −7.3142489E+01 | −3.5296433E+02 | 2.5121065E+02 | −7.9764397E−01 | −3.2664059E+01 |
| 2 | 4.1207988E+04 | 6.0798947E+04 | −1.6601849E+05 | 1.4148373E+05 | −4.4046611E+04 |
| 4 | −4.7375533E+04 | 1.6644575E+05 | −2.0342306E+05 | 1.1689345E+05 | −2.5756464E+04 |
| 5 | −1.4741446E+04 | −4.0607197E+04 | 9.7819504E+04 | −8.3719757E+04 | 2.6794347E+04 |
| 6 | −1.1097790E+04 | 1.1928054E+04 | −8.7697877E+03 | 4.1822011E+03 | −9.6626300E+02 |
| 7 | 3.5845512E+02 | −2.0461724E+03 | 1.8586465E+03 | −6.7635604E+02 | 7.1986448E+01 |
| 8 | −1.7259323E+04 | 1.8913514E+04 | −1.1078838E+04 | 3.3856063E+03 | −4.1312169E+02 |
| 9 | −2.0227320E+02 | −1.9731790E+03 | 2.7590481E+03 | −1.5265793E+03 | 3.1832762E+02 |
| 10 | −1.3778620E+02 | 1.1423182E+02 | −4.2792489E+01 | 4.7947330E+00 | 5.8917235E−01 |
| 11 | −1.1556528E+01 | −1.4766595E+01 | 1.5315808E+01 | −5.9474670E+00 | 8.8361366E−01 |
| 12 | 4.0438506E−01 | −2.9972960E−01 | 1.2701255E−01 | −2.7809883E−02 | 2.4939538E−03 |
| 13 | −4.4623744E−02 | −3.5595460E−02 | 2.1670760E−02 | −4.8145888E−03 | 3.9891043E−04 |

TABLE 3
Example 2
f = 2.382, Bf = 0.845, Fno. = 2.39, 2ω = 100.2, TTL/f = 1.64

| Si | Ri | Di | Ndj | νdj |
|---|---|---|---|---|
| *1 | −2.11850 | 0.349 | 1.54436 | 56.03 |
| *2 | −1.80192 | 0.030 | | |
| 3 (St) | ∞ | 0.018 | | |
| *4 | 2.41366 | 0.456 | 1.54436 | 56.03 |
| *5 | −3.86484 | 0.188 | | |
| *6 | −1.96959 | 0.260 | 1.63350 | 23.62 |
| *7 | 12.14072 | 0.061 | | |
| *8 | 1.51814 | 0.290 | 1.54436 | 56.03 |
| *9 | 3.81101 | 0.413 | | |
| *10 | −1.82483 | 0.490 | 1.54436 | 56.03 |
| *11 | −0.69460 | 0.107 | | |
| *12 | 1.72705 | 0.400 | 1.54436 | 56.03 |
| *13 | 0.55785 | 0.511 | | |
| 14 | ∞ | 0.210 | 1.51633 | 64.14 |
| 15 | ∞ | 0.195 | | |
| 16 (IMG) | ∞ | | | |

*aspherical surface

TABLE 4
Example 2: Aspherical Surface Data

| Surface | | | | | |
|---|---|---|---|---|---|
| Number | KA | A3 | A4 | A5 | A6 |
| 1 | 4.6907017E+00 | 0.0000000E+00 | 4.0282012E−01 | −5.3575855E+00 | 3.5095536E+01 |
| 2 | −4.5302727E+01 | 0.0000000E+00 | −3.2976523E+00 | 3.9236630E+01 | −3.1102869E+02 |
| 4 | 6.7221586E+00 | 0.0000000E+00 | −2.0616978E+00 | 2.9095379E+01 | −1.8894556E+02 |
| 5 | 1.8363528E+01 | 0.0000000E+00 | 7.7863875E−02 | −9.3795599E+00 | 8.5475934E+01 |
| 6 | −2.7675195E−01 | 0.0000000E+00 | 1.4646015E+00 | −2.3927171E+01 | 1.8490734E+02 |
| 7 | −5.0000000E+01 | 0.0000000E+00 | 1.9302345E+00 | −3.0644103E+01 | 1.8357425E+02 |
| 8 | 6.8883220E−01 | 0.0000000E+00 | −2.1755616E+00 | 1.4441752E+01 | −8.6355188E+01 |
| 9 | 3.7810643E+00 | 0.0000000E+00 | −2.9145804E+00 | 3.0589934E+01 | −1.6463105E+02 |
| 10 | −1.9079704E+01 | 0.0000000E+00 | −1.0759112E+00 | 7.5582808E+00 | −3.4965268E+01 |
| 11 | −2.3348619E−01 | 0.0000000E+00 | 4.5491325E−01 | 1.2681060E−01 | −2.5419934E+00 |
| 12 | 2.8906592E−01 | 0.0000000E+00 | −4.4774364E−01 | −7.8349154E−01 | 3.3886376E+00 |
| 13 | −2.5984865E+00 | 0.0000000E+00 | −2.7421593E−01 | 8.3681762E−02 | 2.6047231E−01 |
| | A7 | A8 | A9 | A10 | A11 |
| 1 | −1.2930127E+02 | 2.9137871E+02 | −4.3013781E+02 | 5.2272703E+02 | −7.5095293E+02 |
| 2 | 1.5484795E+03 | −4.6425584E+03 | 7.2081393E+03 | −1.2074114E+03 | −1.2642714E+04 |
| 4 | 6.1921709E+02 | −6.3795391E+02 | −2.5997005E+03 | 8.7244553E+03 | 4.4038824E+03 |
| 5 | −4.4807721E+02 | 1.4814092E+03 | −3.2923710E+03 | 5.0510864E+03 | −5.1337396E+03 |
| 6 | −8.5708125E+02 | 2.3634661E+03 | −3.2758643E+03 | −6.5303644E+02 | 1.1046643E+04 |
| 7 | −6.3592758E+02 | 1.4550523E+03 | −2.3649345E+03 | 3.0451361E+03 | −3.6799389E+03 |
| 8 | 3.0792722E+02 | −5.2179192E+02 | −2.5884030E+01 | 1.7516430E+03 | −2.9283238E+03 |
| 9 | 4.9896493E+02 | −8.6200497E+02 | 7.1054854E+02 | 8.2641119E+01 | −5.1458096E+02 |
| 10 | 9.7075915E+01 | −1.5834544E+02 | 1.4297396E+02 | −5.7682388E+01 | 1.8314612E+01 |
| 11 | 5.2801591E+00 | −5.1418222E+00 | 1.5744680E+00 | 2.3688075E−00 | −3.3587164E+00 |
| 12 | −4.9250065E+00 | 3.6225981E+00 | −6.7812270E−01 | −1.2749339E+00 | 1.2311573E+00 |
| 13 | −1.7204433E−01 | −1.4542154E−01 | 2.5013629E−01 | −1.3266095E−01 | −1.6479047E−03 |
| | A12 | A13 | A14 | A15 | A16 |
| 1 | 1.0331859E+03 | −8.4404492E+02 | 2.1530076E+02 | 1.3640136E+02 | −7.4616896E+01 |
| 2 | 6.9735168E+03 | 3.5940165E+04 | −7.1726447E+04 | 5.3929549E+04 | −1.5122081E+04 |
| 4 | −7.4846438E+04 | 1.7914851E+05 | −2.0658350E+05 | 1.1967572E+05 | −2.7722860E+04 |
| 5 | 2.7316812E+03 | −3.0068251E+00 | 2.1305437E+02 | −1.7894574E+03 | 1.1528381E+03 |
| 6 | −1.9188977E+04 | 1.4446226E+04 | −2.2110598E+03 | −3.4167445E+03 | 1.5907401E+03 |
| 7 | 4.3045233E+03 | −3.9735806E+03 | 2.3119842E+03 | −6.7492969E+02 | 5.7430612E+01 |
| 8 | 1.1639639E+03 | 2.2582570E+03 | −3.4716454E+03 | 1.9562669E+03 | −4.1661955E+02 |
| 9 | −2.7907510E+02 | 1.4068455E+03 | −1.4852495E+03 | 7.1712239E+02 | −1.3839663E+02 |
| 10 | −7.0462993E+01 | 1.1875521E+02 | −9.4127899E+01 | 3.8539106E+01 | −6.6853795E+00 |
| 11 | 1.5071099E+00 | 5.1772080E−01 | −1.0463387E+00 | 5.4782043E−01 | −1.0614540E−01 |
| 12 | −3.8095994E−01 | −6.8472007E−02 | 8.4676742E−02 | −2.3401030E−02 | 2.2729616E−03 |
| 13 | 4.4783960E−02 | −2.7204724E−02 | 7.2540498E−03 | −7.6019732E−04 | 1.9204571E−06 |

TABLE 5
Example 3
f = 2.303, Bf = 0.809, Fno. = 2.39, 2ω = 98.6, TTL/f = 1.73

| Si | Ri | Di | Ndj | νdj |
|---|---|---|---|---|
| *1 | −2.09181 | 0.380 | 1.54436 | 56.03 |
| *2 | −1.77494 | 0.060 | | |
| 3 (St) | ∞ | 0.018 | | |
| *4 | 2.44100 | 0.493 | 1.54436 | 56.03 |
| *5 | −4.06405 | 0.175 | | |
| *6 | −2.19804 | 0.260 | 1.63350 | 23.62 |
| *7 | 8.43657 | 0.068 | | |
| *8 | 1.55714 | 0.290 | 1.54436 | 56.03 |
| *9 | 4.01337 | 0.446 | | |
| *10 | −1.70121 | 0.463 | 1.54436 | 56.03 |
| *11 | −0.69612 | 0.108 | | |
| *12 | 1.75662 | 0.406 | 1.54436 | 56.03 |
| *13 | 0.61506 | 0.511 | | |
| 14 | ∞ | 0.210 | 1.51633 | 64.14 |
| 15 | ∞ | 0.160 | | |
| 16 (IMG) | ∞ | | | |

*aspherical surface

TABLE 6
Example 3: Aspherical Surface Data

| Surface | | | | | |
|---|---|---|---|---|---|
| Number | KA | A3 | A4 | A5 | A6 |
| 1 | 4.6907017E+00 | 0.0000000E+00 | 4.1240192E−01 | −5.0268835E+00 | 3.0325132E+01 |
| 2 | −4.5302727E+01 | 0.0000000E+00 | −2.3504958E+00 | 1.9388744E+01 | −1.0636634E+02 |
| 4 | 6.7221586E+00 | 0.0000000E+00 | −1.7890279E+00 | 3.0459164E+01 | −2.4187322E+02 |
| 5 | 1.8363528E+01 | 0.0000000E+00 | −1.6875541E−01 | −6.9792611E+00 | 6.1575421E+01 |
| 6 | −2.7675195E−01 | 0.0000000E+00 | 1.1069772E+00 | −1.8613092E+01 | 1.2758084E+02 |
| 7 | −5.0000000E+01 | 0.0000000E+00 | 2.7870859E+00 | −4.9928042E+01 | 3.5612146E+02 |
| 8 | 6.8883220E−01 | 0.0000000E+00 | −1.4402189E+00 | 3.2600389E+00 | −2.5759232E+00 |
| 9 | 3.7810643E+00 | 0.0000000E+00 | −3.0113683E+00 | 3.9231470E+01 | −2.6259370E+02 |
| 10 | −1.9079704E+01 | 0.0000000E+00 | −8.3917680E−01 | 4.3260594E+00 | −1.2000511E+01 |
| 11 | −2.3348619E−01 | 0.0000000E+00 | 3.4147291E−01 | 4.1187039E−01 | −3.3979260E+00 |
| 12 | 2.8906592E−01 | 0.0000000E+00 | −4.9808130E−01 | −3.3563012E−01 | 8.1249145E−01 |
| 13 | −2.5984865E+00 | 0.0000000E+00 | −3.1148455E−01 | 2.0576442E−01 | −8.1327367E−02 |
| | A7 | A8 | A9 | A10 | A11 |
| 1 | −9.7811837E+01 | 1.6570937E+02 | −9.1036681E+01 | −1.2427656E+02 | 1.1082740E+02 |
| 2 | 3.5289936E+02 | −6.9540606E+02 | 1.0000236E+03 | −2.5472625E+03 | 8.6340235E+03 |
| 4 | 1.1288545E+03 | −3.4659504E+03 | 7.2638752E+03 | −9.3655452E+03 | −1.6609649E+03 |
| 5 | −2.5943353E+02 | 5.6226957E+02 | −4.0925796E+02 | −1.0324132E+03 | 3.5098530E+03 |
| 6 | −4.9705750E+02 | 1.0836939E+03 | −8.8437527E+02 | −1.5065252E+03 | 4.3978195E+03 |
| 7 | −1.4651763E+03 | 3.7194916E+03 | −5.5176350E+03 | 3.4379693E+03 | 2.0838150E+03 |
| 8 | −2.3672097E+01 | 1.1661088E+02 | −1.9587237E+02 | 3.5700672E+01 | 1.9809631E+02 |
| 9 | 1.1074390E+03 | −3.2421671E+03 | 6.7989931E+03 | −1.0134756E+04 | 1.0277091E+04 |
| 10 | 1.2892592E+01 | 1.9850017E+01 | −6.3168127E+01 | 7.7633202E+00 | 1.6611481E+02 |
| 11 | 7.8175500E+00 | −7.7916101E+00 | −2.7470494E+00 | 1.7801855E+01 | −2.1260585E+01 |
| 12 | 2.0624036E+00 | −7.4722600E+00 | 9.8265266E+00 | −6.8386683E+00 | 3.1907107E+00 |
| 13 | 4.9647528E−01 | −9.4813389E−01 | 7.5925129E−01 | −2.3409303E−01 | −3.8254189E−02 |
| | A12 | A13 | A14 | A15 | A16 |
| 1 | 2.6851117E+02 | −3.9145033E+02 | −2.6715298E+01 | 2.9125994E+02 | −1.3104479E+02 |
| 2 | −1.8430165E+04 | 2.1824959E+04 | −1.2806765E+04 | 2.0421443E+03 | 7.3919826E+02 |
| 4 | 4.9229248E+04 | −1.4100816E+05 | 2.1098930E+05 | −1.6762075E+05 | 5.5471135E+04 |
| 5 | −4.9607911E+03 | 2.9251950E+03 | 1.9930857E+03 | −4.4669913E+03 | 2.1344452E+03 |
| 6 | −2.5040781E+03 | −4.6172133E+03 | 8.9966988E+03 | −6.2156883E+03 | 1.6411322E+03 |
| 7 | −3.9744339E+03 | −1.0793143E+03 | 5.7193704E+03 | −4.3467861E+03 | 1.1137501E+03 |
| 8 | 1.8709380E+02 | −1.1436349E+03 | 1.5049699E+03 | −8.7746168E+02 | 1.9864010E+02 |
| 9 | −6.3014192E+03 | 1.3623888E+03 | 9.5085195E+02 | −7.5433250E+02 | 1.6217487E+02 |
| 10 | −2.8146097E+02 | 2.2229631E+02 | −9.5775010E+01 | 2.2335324E+01 | −2.4111215E+00 |
| 11 | 9.1087768E+00 | 3.9592540E+00 | −6.5549057E+00 | 2.9657604E+00 | −4.8588826E−01 |
| 12 | −2.3453226E+00 | 2.3668829E+00 | −1.4685319E+00 | 4.6212773E−01 | −5.8251078E−02 |
| 13 | 3.1552040E−02 | 1.2814019E−02 | −1.4067195E−02 | 4.1493409E−03 | −4.3496364E−04 |

TABLE 7
Example 4
f = 2.354, Bf = 0.857, Fno. = 2.40, 2ω = 105.6, TTL/f = 1.70

| Si | Ri | Di | Ndj | vdj |
|---|---|---|---|---|
| *1 | −2.12286 | 0.415 | 1.54436 | 56.03 |
| *2 | −1.80832 | 0.035 | | |
| 3 (St) | ∞ | 0.018 | | |
| *4 | 2.42625 | 0.447 | 1.54436 | 56.03 |
| *5 | −3.82315 | 0.183 | | |
| *6 | −1.93753 | 0.262 | 1.63350 | 23.62 |
| *7 | 11.71521 | 0.060 | | |
| *8 | 1.49128 | 0.292 | 1.54436 | 56.03 |
| *9 | 3.80398 | 0.411 | | |
| *10 | −1.88826 | 0.522 | 1.54436 | 56.03 |
| *11 | −0.69662 | 0.090 | | |
| *12 | 1.70347 | 0.400 | 1.54436 | 56.03 |
| *13 | 0.55334 | 0.511 | | |
| 14 | ∞ | 0.210 | 1.51633 | 64.14 |
| 15 | ∞ | 0.208 | | |
| 16 (IMG) | ∞ | | | |

*aspherical surface

TABLE 8
Example 4: Aspherical Surface Data

| Surface | | | | | |
|---|---|---|---|---|---|
| Number | KA | A3 | A4 | A5 | A6 |
| 1 | 4.6907017E+00 | 0.0000000E+00 | 5.2969599E−01 | −9.1104584E+00 | 7.2648800E+01 |
| 2 | −4.5302727E+01 | 0.0000000E+00 | −3.1720851E+00 | 3.7295937E+01 | −2.7667506E+02 |
| 4 | 6.7221586E+00 | 0.0000000E+00 | −1.9021826E+00 | 2.3481301E+01 | −1.0926444E+02 |
| 5 | 1.8363528E+01 | 0.0000000E+00 | −2.4721384E−01 | −4.6218140E+00 | 2.9584691E+01 |
| 6 | −2.7675195E−01 | 0.0000000E+00 | 6.4764225E−01 | −5.4784660E+00 | −9.5404735E+00 |
| 7 | −5.0000000E+01 | 0.0000000E+00 | 1.9142986E+00 | −2.9224262E+01 | 1.6526804E+02 |
| 8 | 6.8883220E−01 | 0.0000000E+00 | −1.7932548E+00 | 7.5476063E+00 | −3.6404180E+01 |
| 9 | 3.7810643E+00 | 0.0000000E+00 | −2.1197178E+00 | 1.4794498E+01 | −4.2430301E+01 |
| 10 | −1.9079704E+01 | 0.0000000E+00 | −1.0195269E+00 | 6.2863549E+00 | −2.5586084E+01 |
| 11 | −2.3348619E−01 | 0.0000000E+00 | 4.6737603E−01 | 1.2847791E−01 | −2.4309435E+00 |
| 12 | 2.8906592E−01 | 0.0000000E+00 | −4.2766777E−01 | −9.8942607E−01 | 4.6412485E+00 |
| 13 | −2.5984865E+00 | 0.0000000E+00 | −2.6797014E−01 | 3.7921587E−02 | 4.1045427E−01 |
| | A7 | A8 | A9 | A10 | A11 |
| 1 | −3.2347565E+02 | 8.6297192E+02 | −1.3202427E+03 | 8.5344066E+02 | 3.2910057E+02 |
| 2 | 1.1711318E+03 | −2.0152323E+03 | −4.6814686E+03 | 3.3422466E+04 | −7.4108350E+04 |
| 4 | 9.3675414E+00 | 2.1876281E+03 | −1.0869637E+04 | 2.4628059E+04 | −1.9776578E+04 |
| 5 | −4.8992190E+01 | −2.2139758E+02 | 1.1920214E+03 | −2.0413102E+03 | 2.8073348E+02 |
| 6 | 2.5524166E+02 | −1.2091643E+03 | 2.4982629E+03 | −1.5862816E+03 | −1.2681118E−03 |
| 7 | −5.1013114E+02 | 9.0552458E+02 | −7.5277792E+02 | −1.7643801E+02 | 6.2225939E+02 |
| 8 | 1.3262610E+02 | −2.8567737E+02 | 3.2620595E+02 | −8.8213659E+01 | −3.0344926E+02 |
| 9 | −6.4345580E+00 | 3.3990783E+02 | −8.4033176E+02 | 7.3913476E+02 | 2.5685685E+02 |
| 10 | 5.9393720E+01 | −6.6926214E+01 | 2.5242869E+00 | 8.4815131E+01 | −9.0443684E+01 |
| 11 | 4.4559328E+00 | −3.7781387E+00 | 1.1406078E+00 | 1.8924807E+00 | −3.5977075E+00 |
| 12 | −9.6615618E+00 | 1.4457968E+01 | −1.5781880E+01 | 1.0869614E+01 | −2.5575087E+00 |
| 13 | −5.0955151E−01 | 3.0760766E−01 | −1.1157083E−01 | 3.2993049E−02 | −3.1696949E−02 |
| | A12 | A13 | A14 | A15 | A16 |
| 1 | −1.4402597E+02 | −2.1666374E+03 | 3.7176103E+03 | −2.5135048E+03 | 6.4123563E+02 |
| 2 | 6.0365062E+04 | 4.8618477E+04 | −1.5059117E+05 | 1.2602313E+05 | −3.8113608E+04 |
| 4 | −2.9960554E+04 | 8.5429449E+04 | −6.9707224E+04 | 9.6670039E+03 | 9.0618541E+03 |
| 5 | 4.0495539E+03 | −6.1139683E+03 | 3.8812955E+03 | −1.2995356E+03 | 3.2045716E+02 |
| 6 | −4.3982597E+03 | 2.5167361E+04 | −4.0831818E+04 | 2.9903964E+04 | −8.5425178E+03 |
| 7 | 7.2415789E+02 | −2.5057569E+03 | 2.4433969E+03 | −1.0549355E+03 | 1.6643798E+02 |
| 8 | 5.5809747E+02 | −5.5723234E+02 | 3.7491696E+02 | −1.5660906E+02 | 2.9699659E+01 |
| 9 | −9.6951533E+02 | 5.0953005E+02 | 2.1398130E+02 | −2.9227653E+02 | 7.8753000E+01 |
| 10 | 1.8938224E+01 | 3.1024089E+01 | −2.7179310E+01 | 9.4326122E+00 | −1.3913704E+00 |
| 11 | 2.6384049E+00 | −5.4570598E−01 | −4.2388540E−01 | 2.9092517E−01 | −5.4924639E−02 |
| 12 | −2.8553046E+00 | 3.2490686E+00 | −1.5271364E+00 | 3.6323516E−01 | −3.5706384E−02 |
| 13 | 3.4037095E−02 | −1.8915129E−02 | 5.1657518E−03 | −5.7182753E−04 | 4.6927112E−06 |

TABLE 9
Values Related to Conditional Formulae

| Formula | Condition | Example 1 | Example 2 | Example 3 | Example 4 |
|---|---|---|---|---|---|
| 1 | f/f1 | 0.156 | 0.149 | 0.152 | 0.154 |
| 2 | f/f2 | 0.84 | 0.85 | 0.80 | 0.84 |
| 3 | f/f3 | −0.899 | −0.897 | −0.844 | −0.904 |
| 4 | f/f5 | 1.34 | 1.33 | 1.24 | 1.34 |
| 5 | f/f6 | −1.38 | −1.38 | −1.16 | −1.37 |
| 6 | f/L6r | 4.26 | 4.27 | 3.74 | 4.26 |

Note that the above paraxial radii of curvature, the distances among surfaces, the refractive indices, and the Abbe's numbers were obtained by measurements performed by specialists in the field of optical measurement, according to the methods described below.

The paraxial radii of curvature were obtained by measuring the lenses using an ultra high precision three dimensional measurement device UA3P (by Panasonic Factory Solutions K. K.) by the following procedures. A paraxial radius of curvature Rₘ (m is a natural number) and a conical coefficient Kₘ are preliminarily set and input into UA3P, and an nth order aspherical surface coefficient An of an aspherical shape formula is calculated from the input paraxial radius of curvature Rₘ and conical coefficient Kₘ and the measured data, using a fitting function of UA3P. C=1/Rₘ and KA=Kₘ−1 are considered in the aforementioned aspherical surface shape formula (A). Depths Z of an aspherical surface in the direction of the optical axis corresponding to heights h from the optical axis are calculated from Rₘ, Kₘ, An, and the aspherical surface shape formula. The difference between the calculated depths Z and actually measured depth values Z′ are obtained for each height h from the optical axis. Whether the difference is within a predetermined range is judged. In the case that the difference is within the predetermined range, Rₘ is designated as the paraxial radius of curvature. On the other hand, in the case that the difference is outside the predetermined range, the value of at least one of Rₘ and Kₘ is changed, set as Rₘ₊₁ and Kₘ₊₁, and input to UA3P. The processes described above are performed, and judgment regarding whether the difference between the calculated depths Z and actually measured depth values Z′ for each height h from the optical axis is within a predetermined range is judged. These procedures are repeated until the difference between the calculated depths Z and actually measured depth values Z′ for each height h from the optical axis is within a predetermined range. Note that here, the predetermined range is set to be 200 nm or less. In addition, a range from 0 to ⅕ the maximum lens outer diameter is set as the range of h.

The distances among surfaces are obtained by measurements using OptiSurf (by Trioptics), which is an apparatus for measuring the central thicknesses and distances between surfaces of paired lenses.

The refractive indices are obtained by performing measurements in a state in which the temperature of a measurement target is 25° C., using KPR-2000 (by K. K. Shimadzu), which is a precision refractometer. The refractive index measured with respect to the d line (wavelength: 587.6 nm) is designated as Nd. Similarly, the refractive index measured with respect to the e line (wavelength: 546.1 nm) is designated as Ne, the refractive index measured with respect to the F line (wavelength: 486.1 mm) is designated as NF, the refractive index measured with respect to the C line (wavelength: 656.3 nm) is designated as NC, and the refractive index measured with respect to the g line (wavelength: 435.8 nm) is designated as Ng. The Abbe's number vd with respect to the d line is obtained by calculations, substituting the values of Nd, NF, and NC obtained by the above measurements into the formula below.

vd=(Nd−1)/(NF−NC).

What is claimed is:

1. An imaging lens consisting of six lenses, including, in order from the object side to the image side:
a first lens having a positive refractive power and is of a meniscus shape with a concave surface toward the object side;
a second lens having a positive refractive power and a convex surface toward the object side;
a third lens having a negative refractive power;
a fourth lens;
a fifth lens; and
a sixth lens having a negative refractive power;
an aperture stop being positioned at the object side of the surface toward the object side of the third lens.

2. An imaging lens as defined in claim 1, wherein:
the second lens is of a biconvex shape.

3. An imaging lens as defined in claim 1, wherein:
the third lens has a concave surface toward the object side.

4. An imaging lens as defined in claim 1, wherein:
the fourth lens has a positive refractive power.

5. An imaging lens as defined in claim 1, wherein:
the fifth lens has a positive refractive power.

6. An imaging lens as defined in claim 1, wherein:
the fifth lens is of a meniscus shape with a concave surface toward the object side.

7. An imaging lens as defined in claim 1, wherein:
the sixth lens is of a meniscus shape with a convex surface toward the object side.

8. An imaging lens as defined in claim 1 in which the conditional formula below is further satisfied:
0.1<f/f1<0.6 (1)
wherein f is the focal length of the entire lens system, and f1 is the focal length of the first lens.

9. An imaging lens as defined in claim 1 in which the conditional formula below is further satisfied:
0.6<f/f2<1.1 (2)
wherein f is the focal length of the entire lens system, and f2 is the focal length of the second lens.

10. An imaging lens as defined in claim 1 in which the conditional formula below is further satisfied:
−1.6<f/f3<−0.4 (3)
wherein f is the focal length of the entire lens system, and f3 is the focal length of the third lens.

11. An imaging lens as defined in claim 1 in which the conditional formula below is further satisfied:
1.1<f/f5<1.6 (4)
wherein f is the focal length of the entire lens system, and f5 is the focal length of the fifth lens.

12. An imaging lens as defined in claim 1 in which the conditional formula below is further satisfied:
−1.9<f/f6<−1.15 (5)
wherein f is the focal length of the entire lens system, and f6 is the focal length of the sixth lens.

13. An imaging lens as defined in claim 1 in which the conditional formula below is further satisfied:
1<f/L6r<6 (6)
wherein f is the focal length of the entire lens system, and L6r is the paraxial radius of curvature of the surface of the sixth lens toward the image side.

14. An imaging lens as defined in claim 8 in which the conditional formula below is further satisfied:
0.1<f/f1<0.4 (1-1)
wherein f is the focal length of the entire lens system, and f1 is the focal length of the first lens.

15. An imaging lens as defined in claim 9 in which the conditional formula below is further satisfied:
0.7<f/f2<1 (2-1)
wherein f is the focal length of the entire lens system, and f2 is the focal length of the second lens.

16. An imaging lens as defined in claim 10 in which the conditional formula below is further satisfied:
−1.2<f/f3<−0.6 (3-1)
wherein f is the focal length of the entire lens system, and f3 is the focal length of the third lens.

17. An imaging lens as defined in claim 11 in which the conditional formula below is further satisfied:
1.2<f/f5<1.4 (4-1)
wherein f is the focal length of the entire lens system, and f5 is the focal length of the fifth lens.

18. An imaging lens as defined in claim 12 in which the conditional formula below is further satisfied:
−1.6<f/f6<−1.15 (5-1)
wherein f is the focal length of the entire lens system, and f6 is the focal length of the sixth lens.

19. An imaging lens as defined in claim 13 in which the conditional formula below is further satisfied:
3<f/L6r<5 (6-1)
wherein f is the focal length of the entire lens system, and L6r is the paraxial radius of curvature of the surface of the sixth lens toward the image side.

20. An imaging apparatus equipped with an imaging lens as defined in claim 1.
